(19) United States
(12) Patent Application Publication
(10) Pub. No.: US 2018/0107509 A1
(43) Pub. Date: Apr. 19, 2018

(54) MIGRATION OF COMPUTER SYSTEMS

(71) Applicants: Adrian SHAW, Bristol (GB); Kate MALLICHAN, Bristol (GB); David PLAQUIN, Bristol (GB); Hewlett Packard Enterprise Development LP, Houston, TX (US)

(72) Inventors: Adrian Shaw, Bristol (GB); Kate Mallichan, Bristol (GB); David Plaquin, Bristol (GB)

(21) Appl. No.: 15/573,542

(22) PCT Filed: Jul. 31, 2015
(86) PCT No.: PCT/EP2015/067659

§ 371 Date: Nov. 13, 2017

(51) Int. Cl. G06F 9/48; G06F 9/44

(52) U.S. Cl. CPC G06F 9/4856; G06F 9/4406

(57) ABSTRACT

An example method for migrating a live operating system from a first computing device to a second computing device is provided. The example method comprises (a) providing register values of a processor of a first computing device to a second computing device which is in communication with the first computing device; (b) providing contents of a dynamic random access memory, DRAM, of the first computing device to the second computing device; (c) storing the register values in a protected memory of the second computing device, wherein the protected memory is separate from a memory used by the second computing device during normal operation of the second computing device; (d) storing the contents of the DRAM of the first computing device in a DRAM of the second computing device; and (e) loading the register values from the protected memory to registers of a processor of the second computing device.

### BACKGROUND

Migration of a computer system from a first node to a second node can be achieved by encapsulating the computer system in a virtual machine and then using an entity (e.g. a hypervisor) to transfer the state of the computer system to the second node without interrupting the execution of the virtual machine.

### BRIEF DESCRIPTION OF THE DRAWINGS

The following detailed description references the drawings, wherein:

FIG. 1 is a block diagram of an example first computing device and an example second computing device;

FIG. 2 is a block diagram of an example first computing device and an example second computing device;

FIG. 3 is block diagram of an example first computing device and an example second computing device; and;

FIG. 4 is a flowchart of an example method for execution by an example first computing device and an example second computing device;

FIG. 5 is a flowchart of an example method for execution by an example first computing device;

FIG. 6 is a flowchart of an example method for execution by an example second computing device;

FIG. 7 is a flowchart of an example method for execution by an example first computing device and an example second computing device;

FIG. 8 is a flowchart of an example method for execution by an example second computing device;

FIG. 9 is a flowchart of an example method for execution by an example first computing device; and

FIG. 10 is a flowchart of an example method for execution by an example second computing device.

### DETAILED DESCRIPTION

The following detailed description refers to the accompanying drawings. It is to be expressly understood that the drawings are for the purpose of illustration and description only. While several examples are described in this document, modifications, adaptations, and other implementations are possible. Accordingly, the following detailed description does not limit the disclosed examples. Instead, the proper scope of the disclosed examples may be defined by the appended claims.

Live migration of a computer system from a first physical device to a second physical device can be achieved by encapsulating the computing system in a virtual machine. Creation of a virtual machine involves an entity (such as a virtual machine manager (VMM) or a hypervisor) virtualizing the memory of the computer system, recording all of the interactions of the computer system, and emulating the hardware devices and CPU instructions of the first physical device. The hypervisor can then gradually transfer the state of the computer system to the second physical device without interrupting the execution of the virtual machine. Workload programs can thereby be moved across different machines without kernel support or program modification, and do not have to be restarted after the move.

A technical challenge may exist with using virtual machines to live migrate a computer system from one physical device to another. It is not always possible to run a program such as a hypervisor or VMM. For example, the underlying hardware (e.g. the CPU) of one or both of the physical devices may not provide virtualization support, which would cause the performance of a virtual machine to be very slow. Furthermore, any hypervisor is associated with a performance overhead, and on some systems, e.g. systems which have constrained resources, incurring this performance overhead is not feasible. Furthermore it is not always possible to have workloads running in virtual machines. For example, a hypervisor or VMM may present generic virtualized versions of the actual host hardware to the operating system that runs in its virtual machines, but some applications/workloads in the virtual machines may use specific features of the underlying hardware devices that are not available in a virtualized environment.

Examples disclosed herein provide technical solutions to these technical challenges. An example method provides a hardware-based process for the migration of a live operating system from a first physical computing device to a second physical computing device.

The terminology used herein is for the purpose of describing particular examples and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “coupled,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

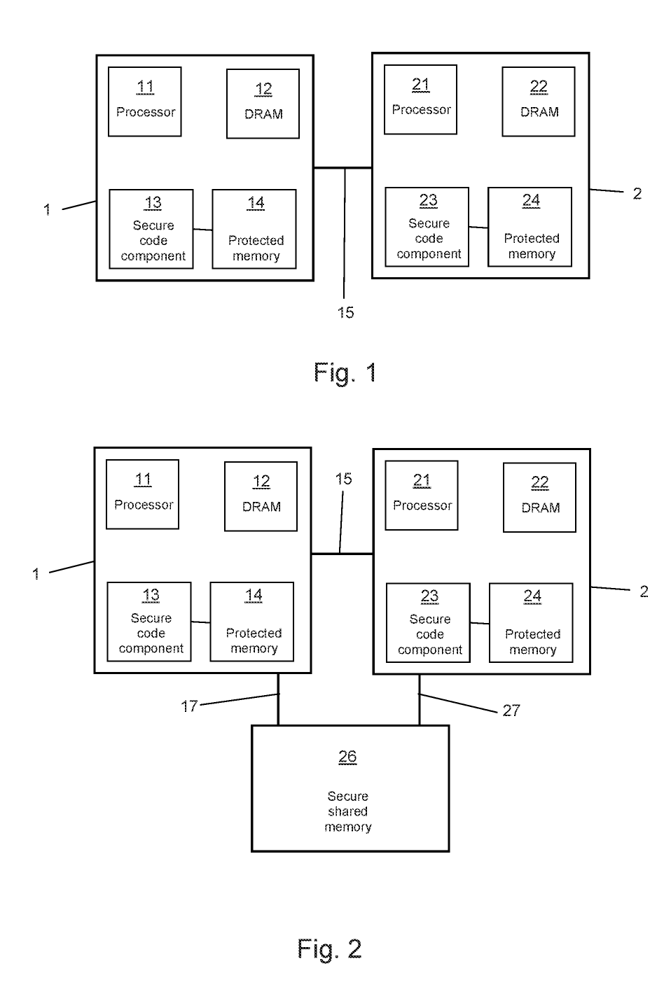

FIG. 1 shows an example first computing device 1 and an example second computing device 2 that can implement a hardware-based method for the migration of a live operating system from one physical device to another.

The first computing device 1 may be a “source” computing device, i.e. it comprises an operating system which is to be moved to another, “target” computing device. The first computing device 1 comprises a processor 11, a dynamic random access memory (DRAM) 12, and a secure code component 13. The processor 11 can be any type of processor, including, for example, a central processing unit (CPU), a graphics processing unit (GPU), a digital signal processor (DSP), etc. The DRAM 12 is for use by the processor 11 to store data, during normal operation of the first computing device 1.

By “normal operation” is meant operation of a computing device to perform its intended basic functionality. For example the intended basic functionality of a general purpose computer such as a PC or laptop is to execute programs of varying types, in response to inputs from a user. For the purposes of the current specification, “normal operation” of a computing device does not include performing operations involved in a migration process, and nor does it include operation in any secure mode associated with a migration process.

The secure code component 13 is to be executed in response to a migration command received by the first computing device 1. In some examples the secure code component 13 is to be executed in response to a migration command from a hardware management system (e.g. a program running on a management server machine, which may manage several physical machines over a network). The secure code component may comprise, e.g., a piece of trusted code, trusted firmware, a trusted execution environment (TEE), etc. A TEE may be based, for example, on the proprietary TrustZone technology supplied by ARM. The secure code component 13 may be comprised in a CPU of the first computing device 1. The secure code component 13 may be comprised in the processor 11. In some examples the secure code component 13 supports physical memory, CPU and I/O partitioning (e.g. into a secure part and a non-secure part).

The secure code component 13 comprises instructions which, when executed (e.g. by a processor of the first (source) computing device), cause the first computing device to:
make available, to a target computing device (e.g. the second computing device 2), register values of the processor 11; and
make available, to the target computing device (e.g. the second computing device 2), data stored in the DRAM 12.

Making the register values and data available to a target computing device may comprise the first computing device sending the register values and data to the target computing device via a communications link, e.g. a network. Such a communications link may be a secure communications link. Making the register values and data available to a target computing device may comprise the first computing device storing the register values and data in a memory which is accessible by the target computing device. Such a memory may be a secure memory. A secure memory may be accessible by the secure code components of the source and/or target computing devices, but not accessible by any other components of the source and target computing devices. For example, a secure memory may not be accessible by the source computing device during normal operation of the source computing device, or by the target computing device during normal operation of the target computing device. In some examples a secure memory is physically protected by the CPU/chipset of the source computing device and/or the target computing device. For example, on a personal computer (PC) the RAM is split between the BIOS and the operating system. The BIOS can reserve part of the memory (say, 16 MB) for exclusive use by the BIOS, such that the reserved memory can be accessed when the processor of the PC is operating in a “secure mode” (called SMM), in which the operating system is suspended and instead the BIOS has execution control, but cannot be accessed during normal operation of the processor. A similar arrangement can be created by the ARM TrustZone technology. In particular, TrustZone can partition the address space of a RAM into two parts, such that each part is used exclusively by separate modes of a processor (i.e. one part is used exclusively by a secure mode and the other part is used exclusively by a for normal operation mode).

In some examples making data stored in the DRAM 12 available to the target computing device 2 comprises making at least part of an address space of the DRAM 12 available to the target computing device. In some examples making data stored in the DRAM 12 available to the target computing device 2 comprises making available regions of an address space of the DRAM 12 which contain data and not making available regions of the address space of the DRAM 12 which do not contain data. For example, the address space of the DRAM 12 may contain I/O regions and/or memory holes, in which case these regions will, in some examples, not be made available to the target computing device 2.

The instructions are arranged such that, when executed, they cause the first computing device to suspend normal operation during the performing of the operations specified by the instructions (i.e. the operations of making available register values, making available data, etc.). In some examples the instructions are arranged such that, when executed, they cause the first computing device to suspend normal operation during the performing of all of the operations specified by the instructions. In some examples the instructions are arranged such that, when executed, they cause the first computing device to suspend normal operation unless or until a command to resume normal operation is received by the first computing device.

Suspending normal operation comprises transitioning the first computing device to a secure operation mode, such that the operations specified by the instructions are performed whilst the first computing device is in the secure operating mode. In some examples, when a computing device is in a “secure operating mode”, any program, process, etc, that executes on the device is completely isolated from any program, process, etc. that executes on the device when it is in a “normal operating mode”. Thus, providing a secure operating mode enables secure programs to be run externally to, and protected from, the normal operating system on the device. In some examples the secure code component of the first computing device is to execute in a secure mode of the first computing device. Furthermore, a code component which executes in a secure mode of a computing device (e.g. the secure code component of the first computing device) can have full access to the register contents and DRAM of the normal operating mode of the computing device, because it executes outside of that normal operating environment.

The instructions may be arranged such that, when executed, they cause the first computing device to perform the operations specified by the instructions within a predefined maximum time period. A predefined maximum time period may be of the order of a few seconds. A predefined maximum time period may be less than one second. A predefined maximum time period may be in the range 0.1 s to 1 s. The predefined maximum time period may be set, e.g. by an operator initiating a migration process. The predefined maximum time period may be selected, e.g. by an operator, based on the capability of the operating system being migrated to withstand clock drift. For example, if the operating system being migrated can withstand significant clock drift the predefined maximum time period may be longer than if the operating system being migrated cannot withstand significant clock drift.

In some examples the first computing device 1 further comprises a protected memory 14. The protected memory 14 may be separate from a memory used by the first computing device during normal operation of the first computing device 1. The protected memory 14 may be separate from each memory used by the first computing device during normal operation of the first computing device 1. In some examples the protected memory 14 is created by the secure code component 13. For example, the protected memory may be configured by the secure code component during the boot process of the first computing device 1. The protected memory 14 may be used by the secure code component to store data during a process of migrating an operating system of the first computing device to another computing device, e.g. the second computing device.

The second computing device 2 may be a “target” computing device; i.e. it is to receive an operating system which has been moved from a source computing device. Properties of the second computing device 2 may meet certain predefined criteria, wherein the predefined criteria are defined such that a computing device having properties meeting the criteria is suitable to be a target computing device for receiving an operating system from a source computing device during a migration process, and a computing device having properties which do not meet the criteria is not suitable to be a target computing device for receiving an operating system from a source computing device during a migration process. The properties may comprise, e.g., firmware version, memory size, CPU model. In some examples properties of the second computing device may meet the predefined criteria if they match corresponding properties of the first (source) computing device.

The second computing device 2 comprises a processor 21, a DRAM 22, and a secure code component 23. The processor 21 can be any type of processor, including, for example; a central processing unit (CPU), a graphics processing unit (GPU), a digital signal processor (DSP), etc. The processor 21 of the second computing device 2 is identical to the processor 11 of the first computing device 1. In particular the hardware of the processor 21 of the second computing device 2 is identical to the hardware of the processor 11 of the first computing device 1. The DRAM 22 is for use by the processor 21 to store data, during normal operation of the second computing device 2. The DRAM 22 of the second computing device has an identical memory layout to the DRAM 12 of the first computing device. The memory contents of a DRAM are highly specific to the configuration of the DRAM, meaning that if the configuration of the DRAM on the target device (i.e. the DRAM 22) does not match the configuration of the DRAM on the source device (i.e. the DRAM 12), then the target computing device may fail to operate correctly when it is returned to a normal operating mode following completion of the migration process.

The secure code component 23 is to be executed in response to a migration command received by the second computing device 1. In some examples the secure code component 23 is to be executed in response to a migration command from a hardware management system (e.g. a program running on a management server machine, which may manage several physical machines over a network). The secure code component may comprise, e.g., a piece of trusted code, trusted firmware, a trusted execution environment (TEE), etc. The secure code component 23 may be comprised in a CPU of the second computing device 2. The secure code component 23 may be comprised in the processor 21. In some examples the secure code component 23 supports physical memory, CPU and I/O partitioning. The secure code component 23 may be the same as the secure code component 13 of the first computing device 1.

The second computing device 2 further comprises a protected memory 24. The protected memory 24 is separate from a memory used by the second computing device during normal operation of the second computing device 2. The protected memory 24 may be separate from each memory used by the second computing device during normal operation of the second computing device 2. In some examples the protected memory 24 is created by the secure code component 23. For example; the protected memory may be configured by the secure code component during the boot process of the first computing device 2. The protected memory 24 may be used by the secure code component to store data during a process of migrating an operating system of the first computing device 1 to the second computing device 2.

The secure code component 23 comprises instructions which, when executed (e.g. by a processor of the second computing device 2), cause the second (target) computing device to:
receive register values of a processor of a source computing device (e.g. the first computing device 1);
store the received register values in the protected memory 24;
receive data stored in the DRAM of a source computing device (e.g. the first computing device 1);
store the received data in a DRAM of the target (second) computing device (e.g. the DRAM 22); and
load the register values from the protected memory 24 to registers of the processor 21.

Receiving the register values and data from a source computing device may comprise the target computing device receiving the register values and data to the target computing device via a communications link, e.g. a network. Such a communications link may be a secure communications link. Receiving the register values and data from a source computing device may comprise the target computing device retrieving the register values and data from a memory accessible by the target computing device. Such a memory may be a secure memory; e.g. protected by an encryption key.

Storing the register values in the protected memory 24 may comprise overwriting register values already contained in the protected memory 24 (e.g. register values of a processor of the second computing device 2). In some examples, a processor of the first computing device and/or a processor of the second computing device may comprise embedded or internal processor state that cannot be replicated by copying register values from the first computing device to the second computing device. In such examples, drivers of the operating system (i.e. the operating system being migrated) may be arranged to handle faults caused by a difference in such embedded or internal processor state as between a processor of the first computing device 1 and a processor of the second computing device 2.

The instructions may be arranged such that, when executed, the operation of loading the register values is performed automatically in response to both of the operations of storing the received register values and storing the received data having been completed. The instructions may be arranged such that, when executed, the operation of loading the register values is performed in response to the second computing device 2 receiving a command, e.g. to load the register values and/or to enter a normal operation mode, etc. Such a command may comprise an interrupt.

The instructions are arranged such that, when executed, they cause the second computing device to suspend normal operation during the performing of the operations specified by the instructions (i.e. the operations of receiving register values, storing the received register values, receiving data, storing the received data, and loading the register values, etc.). In some examples the instructions are arranged such that, when executed, they cause the second computing device to suspend normal operation during the performing of all of the operations specified by the instructions. In some examples the instructions are arranged such that, when executed, they cause the second computing device to suspend normal operation unless or until a command to resume normal operation is received by the second computing device.

Suspending normal operation comprises transitioning the second computing device to a secure operation mode, such that the operations specified by the instructions are performed whilst the second computing device is in the secure operating mode. A secure operation mode of the second computing device may have any of the features of the secure operation mode of the first computing device as described above. A secure operation mode of the second computing device is identical to a secure operation mode of the first computing device.

In some examples the instructions are arranged such that, when executed, they cause the second computing device to synchronise settings of the processor of the second computing device with settings of the processor of the first computing device. In some examples the instructions are arranged such that, when executed, they cause the second computing device to synchronise settings of the processor of the second computing device with settings of the processor of the first computing device before the second computing device loads the register values from the protected memory. This feature may advantageous if, for example, a processor of the first computing device and/or a processor of the second computing device comprises embedded or internal processor state that cannot be replicated by copying register values from the first computing device to the second computing device.

The instructions may be arranged such that, when executed, they cause the second computing device to perform the operations specified by the instructions within a predefined maximum time period. A predefined maximum time period may be of the order of a few seconds. A predefined maximum time period may be less than one second. A predefined maximum time period may be in the range 0.1 s to 1 s. The predefined maximum time period may be set, e.g. by an operator initiating a migration process. The predefined maximum time period may be selected, e.g. by an operator, based on the capability of the operating system being migrated to withstand clock drift. For example, if the operating system being migrated can withstand significant clock drift the predefined maximum time period may be longer than if the operating system being migrated cannot withstand significant clock drift.

The first computing device 1 and the second computing device 2 are coupled by a communications link 15. The communications link 15 may be a high-speed communications link. The communications link 15 may be an optical communications link. The communications link 15 may comprise a wired or wireless communications network.

In some examples the communications link is arranged so as to enable a migration of an operating system from the first computing device 1 to the second computing device 2 to be performed within a maximum time period. The maximum time period may be a predefined maximum time period. The duration of the maximum time period may be of the order of a few seconds. A predefined maximum time period may be less than one second. A predefined maximum time period may be in the range 0.1 s to 1 s. The predefined maximum time period may be set, e.g. by an operator initiating a migration process. The predefined maximum time period may be selected, e.g. by an operator, based on the capability of the operating system being migrated to withstand clock drift. For example, if the operating system being migrated can withstand significant clock drift the predefined maximum time period may be longer than if the operating system being migrated cannot withstand significant clock drift. Performing a migration within a maximum time period may comprise the first computing device 1 performing the operations specified by the instruction set of its secure code component 13 and the second computing device 2 performing the operations specified by the instruction set of its secure code component 23 within the maximum time period. Performing a migration within a short time period can prevent errors occurring in the execution of time or clock dependent programs running during the migration.

In FIG. 1 and other Figures described herein, different numbers of components, processing units, or entities than depicted may be used. For example, the first and second computing devices 1, 2 may comprise multiple processors and or multiple DRAMs.

In some examples a first, source computing device and a second, target computing device are each able to access a secure shared memory. In some examples the source computing device is able to access the secure shared memory when operating in a secure mode and the target computing device is able to access the secure shared memory when operating in a secure mode. The secure shared memory may be accessible by the secure code components of the source and target computing devices, but not accessible by any other components of the source and target computing devices. For example, a secure memory may not be accessible by the source computing device during normal operation of the source computing device, or by the target computing device during normal operation of the target computing device. FIG. 2 shows one such example, in which the first computing device 1 and the second computing device 2 are each able to access a secure shared memory 26. The first computing device 1 may be connected to the secure shared memory 26 by a communications link 17 and the second computing device 2 may be connected to the secure shared memory 26 by a communications link 27. The communications links 17, 27 may be high-speed communications links. The communications links 17, 27 may be optical communications links. One or both of the communications links 17, 27 may comprise a wired or wireless communications network. In some examples the first and second computing devices are each physically coupled to the secure shared memory 26. The secure shared memory 26 may be a non-volatile memory (NVM). In some examples the secure shared memory 26 is encrypted, in which case each of the first and second computing devices is provided with an encryption key for accessing the secure shared memory 26. In some such examples a centralised key manager (e.g. on a secure server in communication with the first and second computing devices) mediates access of encryption keys for the secure shared memory 26.

In examples in which a first, source computing device and a second, target computing device are each able to access a secure shared memory (e.g. the example of FIG. 2), the instruction set of the secure code component 13 of the first computing device 1 may be arranged such that, when executed (e.g. by a processor of the first computing device), the first computing device makes the register values of the processor 11 of the first computing device 1 available to the second computing device 2 by storing the register values in the secure shared memory 26. The instruction set of the secure code component 13 of the first computing device 1 may be arranged such that, when executed (e.g. by a processor of the first computing device), the computing device makes the register values of the processor 11 of the first computing device 1 available to the second computing device 2 by sending a message to the second computing device 2. Such a message may comprise an indication that the register values have been stored in the secure shared storage 26. Such a message may comprise an indication of a location of the register values in the secure shared storage 26.

The instruction set of the secure code component 13 of the first computing device 1 may be arranged such that, when executed (e.g. by a processor of the first computing device), the computing device makes the data stored in the DRAM 12 of the first computing device 1 available to the second computing device 2 by storing the data in the secure shared memory 26. The instruction set of the secure code component 13 of the first computing device 1 may be arranged such that, when executed (e.g. by a processor of the first computing device), the computing device makes the data stored in the DRAM 12 of the first computing device 1 available to the second computing device 2 by sending a message to the second computing device 2. Such a message may comprise an indication that the DRAM contents have been stored in the secure shared storage 26. Such a message may comprise an indication of a location of the DRAM contents in the secure shared storage 26.

In such examples the instruction set of the secure code component 23 of the second computing device 2 may be arranged such that, when executed (e.g. by a processor of the second computing device), the second computing device 2 receives the register values of the processor 11 of the first computing device 1 by retrieving the register values from the secure shared memory 26. In some examples the second computing device may retrieve the register values responsive to the second computing device receiving a message from the first computing device. The message may indicate that the register values have been stored in the secure shared storage, and/or may indicate a location of the register values in the secure shared storage.

The instruction set of the secure code component 23 of the second computing device 2 may be arranged such that, when executed (e.g. by a processor of the second computing device), the second computing device 2 receives the data stored in the DRAM 12 (i.e. the contents of the DRAM 12) of the first computing device 1 by retrieving the data from the secure shared memory 26. In some examples the second computing device may retrieve the DRAM contents responsive to the second computing device receiving a message from the first computing device. The message may indicate that the DRAM contents have been stored in the secure shared storage, and/or may indicate a location of the DRAM contents in the secure shared storage.

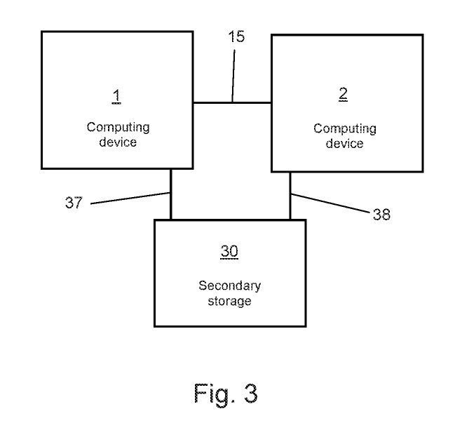

In some examples a secondary storage is associated with and accessible by a source computing device. In some examples a secondary storage is associated with and accessible by a source computing device, and is also accessible by a target computing device. FIG. 3 shows one such example, in which the first computing device 1 and the second computing device 2 are each able to access a secondary storage 30. The first computing device may store data in the secondary storage 30 during normal operation of the first computing device. The first computing device 1 may be connected to the secondary storage 30 by a communications link 37 and the second computing device 2 may be connected to the secondary storage 30 by a communications link 38. The communications links 37, 38 may be high-speed communications links. The communications links 37, 38 may be optical communications links. One or both of the communications links 37, 38 may comprise a wired or wireless communications network. In some examples the first and second computing devices are each physically coupled to the secondary storage 30. The secondary storage 30 may be a non-volatile memory (NVM).

In the example of FIG. 3, the instruction set of the secure code component 13 of the first computing device 1 is arranged such that, when executed (e.g. by a processor of the first computing device), it causes the first computing device 1 to make the contents of the secondary storage 30 available to the second computing device 2. The first computing device may make the contents of the secondary storage 30 available to the second computing device 2 in any of the manners described above in relation to making the register values and DRAM data available to the second computing device.

In some examples the secondary storage 30 is encrypted, in which the first computing device 1 comprises an encryption key for accessing the secondary storage 30. In some such examples a centralised key manager mediates access of encryption keys for the secondary storage 30. A centralised key manager may be comprised, for example, in a third computing device which is in communication with the first computing device 1 and the second computing device 2, and which is trusted by both the first computing device 1 and the second computing device 2. In some examples the instruction set of the secure code component 13 of the first computing device 1 is arranged such that, when executed (e.g. by a processor of the first computing device), it causes the first computing device 1 to make available to the second computing device 2 an encryption key to enable the second computing device 2 to decrypt the secondary storage 30 (or to decrypt the contents of the secondary storage 30).

The first computing device 1 may make an encryption key available to the second computing device 2 by sending a request to a centralised key manager to provide an encryption key to the second computing device 2. A centralised key manager may validate such a request before providing a key to the second computing device 2. Providing a key to the second computing device 2 may comprise the centralised key manager transferring ownership of an encryption key from the first computing device 1 to the second computing device 2. Providing a key to the second computing device 2 may comprise the centralised key manager creating an additional encryption key for use by the second computing device 2, such that both the first and second computing devices are able to decrypt the secondary storage 30 (or contents thereof).

In some examples a secondary storage is associated with and accessible by a source computing device but is not accessible by a target computing device (e.g. because the target device is not coupled to the secondary storage. In such examples making the contents of the secondary storage 30 available to the second computing device may comprise the first computing device 1 sending (e.g. via communications link 15) the contents of the secondary storage 30 to the second computing device 2. In some examples making the contents of the secondary storage 30 available to the second computing device may comprise the first computing device 1 storing the contents of the secondary storage in a secure shared memory accessible by the second computing device (e.g. the secure shared memory 26).

In examples in which a target computing device cannot access a secondary storage associated with a source computing device, receiving the contents of the secondary storage by the second computing device may comprise the second computing device receiving the contents via a communications link with the first computing device, e.g. the communications link 15. In some examples receiving the contents of the secondary storage may comprise the second computing device retrieving the contents of the secondary storage device from a secure shared memory (e.g. the secure shared memory 26). In some examples the instruction set of the secure code component of the second computing device is arranged such that, when executed, it causes the second computing device to store the contents of the secondary storage. The second computing device may store the contents of the secondary storage in a memory comprised in or accessible by the second computing device, e.g. the DRAM 22, the protected memory 24, or the secure shared storage 26.

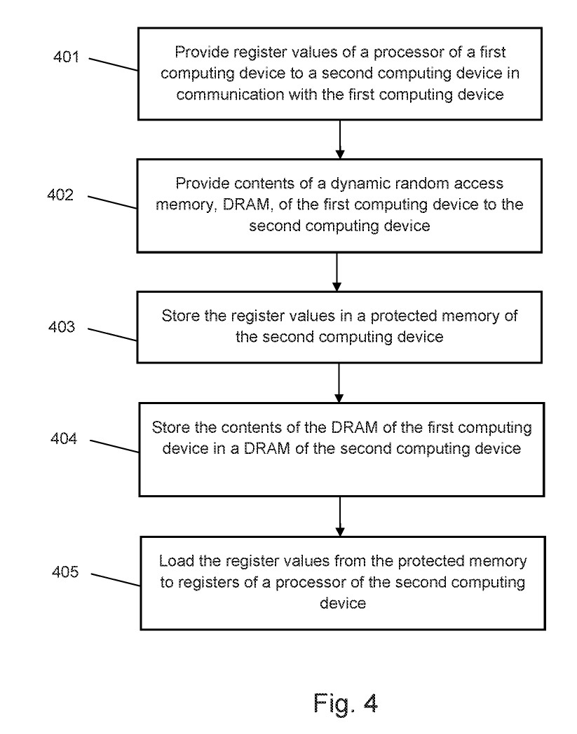

FIG. 4 is a flowchart of an example method for execution by an example first (source) computing device and an example second (target) computing device, e.g. for migrating a live operating system from the first computing device to the second computing device. Although execution of the methods described below are with reference to the first and second computing devices of FIGS. 1-3, other suitable devices for execution of this method may be employed to practice the present techniques. The flow diagram described in FIG. 4 and other figures may be implemented in the form of executable instructions (e.g. the instruction set of the secure code component 13 and/or the instruction set of the secure code component 23) stored on a machine-readable storage medium, such as the protected memory 14, the protected memory 24, and/or the secure shared memory 26, by a component or multiple components described herein, and/or in the form of electronic circuitry.

The various processing blocks and/or data flows depicted in FIG. 4 are described in greater detail herein. The described processing blocks may be accomplished using some or all of the system components described in detail above and, in some implementations, various processing blocks may be performed in different sequences and various processing blocks may be omitted. Additional processing blocks may be performed along with some or all of the processing blocks shown in the depicted flow diagrams. Some processing blocks may be performed simultaneously. Accordingly, the operations depicted in the flow diagram as illustrated (and described in greater detail below) are meant be an example and, as such, should not be viewed as limiting.

In block 401, register values of a processor (e.g. the processor 11) of a first computing device (e.g. the first computing device 1) are provided to a second computing device (e.g. the second computing device 2) which is in communication with the first computing device. Providing the register values may be effected in any of the manners described above in relation to the operation of the first computing device 1.

In block 402, contents of a DRAM (e.g. the DRAM 12) of the first computing device are provided to the second computing device. The contents of the DRAM may comprise data stored in the DRAM by the first computing device during normal operation of the first computing device. Providing the register values may be effected in any of the manners described above in relation to the operation of the first computing device 1.

In block 403 the register values (i.e. the provided register values of the processor of the first computing device) are stored, e.g. by the second computing device, in a protected memory (e.g. the protected memory 24) of the second computing device. The protected memory is separate from a memory used by the second computing device during normal operation of the second computing device. The storing of the register values may be effected in any of the manners described above in relation to the operation of the computing device 2.

In block 404 the contents of the DRAM (i.e. the contents of the DRAM of the first computing device) are stored, e.g. by the second computing device, in a DRAM (e.g. the DRAM 22) of the second computing device. The DRAM of the second computing device may be a DRAM used by the second computing device to store data during normal operation of the second computing device. The storing of the DRAM contents/data may be effected in any of the manners described above in relation to the operation of the computing device 2.

In block 405, the register values are loaded, e.g. by the second computing device 2, to registers of a processor (e.g. the processor 21) of the second computing device. The loading of the register values may be effected in any of the manners described above in relation to the operation of the computing device 2. Block 405 may be performed automatically in response to the completion of the performance of blocks 403 and 404. Block 405 may be performed in response to the receipt of a command, e.g. from a remote node, from an operator of the first and/or the second computing devices, etc. Block 405 may be performed in response to the receipt of a command to transition to a normal operation mode.

In some examples Blocks 401-505 are completed within a maximum time period. The maximum time period may have any of the features described above in relation to the operation of the first and second computing devices 1, 2.

In some examples blocks 401 and 402 are performed by a secure code component comprised in the first computing device and blocks 403, 404 and 405 are performed by a secure code component comprised in the second computing device. Such secure code components of the first and second computing devices may have any of the features described above in relation to the operation of the first and second computing devices 1, 2.

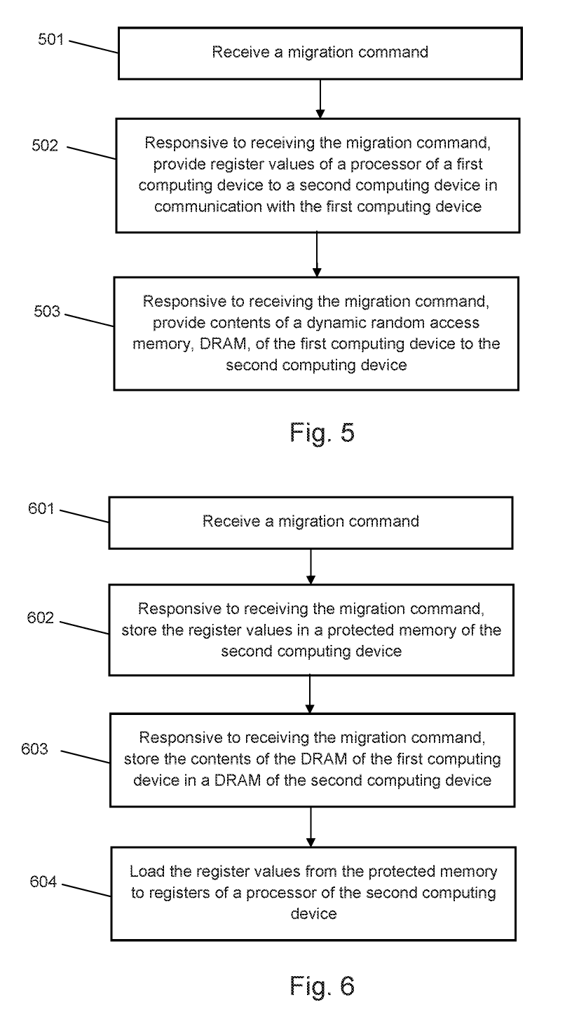

In some examples blocks 401 and 402 are performed responsive to the first computing device receiving a migration command. FIG. 5 is a flowchart of an example method for execution by an example first (source) computing device, which involves the receiving of a migration command. In block 501, a migration command is received, e.g. by the first computing device 1). The migration command may have any of the features described above in relation to the operation of the first computing device. Block 502 corresponds to block 401 of FIG. 4. Block 503 corresponds to block 402 of FIG. 4. Blocks 502 and 503 are performed responsive to the receiving of the migration command. Blocks 502 and 503 may be performed in the same manner as blocks 401 and 402, respectively, of FIG. 4.

In some examples blocks 403 and 404 are performed responsive to the second computing device receiving a migration command. FIG. 6 is a flowchart of an example method for execution by an example second (target) computing device, which involves the receiving of a migration command. In block 601, a migration command is received, e.g. by the second computing device 2). The migration command may have any of the features described above in relation to the operation of the second computing device. Block 602 corresponds to block 403 of FIG. 4. Block 603 corresponds to block 404 of FIG. 4. Block 604 corresponds to block 405 of FIG. 4. Blocks 602 and 603 are performed responsive to the receiving of the migration command. Blocks 602, 603 and 604 may be performed in the same manner as blocks 403, 404 and 405, respectively, of FIG. 4.

Normal operation of the first computing device is suspended during the performing of blocks 401 and 402. Normal operation of the second computing device is suspended during the performing of blocks 403, 404 and 405. Suspending normal operation of the first computing device comprises transitioning the first computing device to a secure operation mode. Suspending normal operation of the second computing device comprises transitioning the second computing device to a secure operating mode. The secure operation mode of the first computing device may have any of the features described above in relation to the operation of the first computing device 1. The secure operation mode of the second computing device may have any of the features described above in relation to the operation of the second computing device 2.

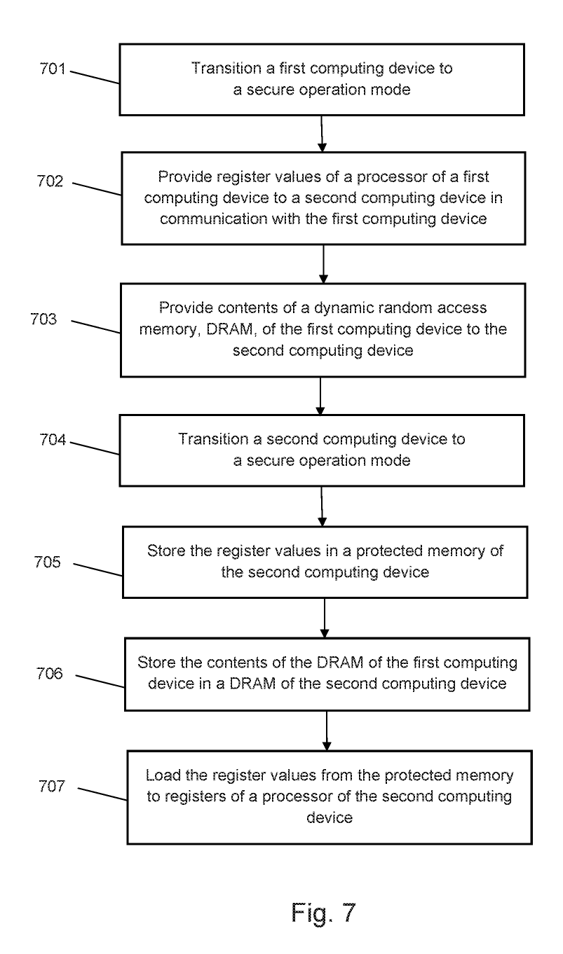

FIG. 7 is a flowchart of an example method for execution by an example first (source) computing device and an example second (target) computing device, which involves transitioning the first and second computing devices into a secure operation mode.

In block 701, a first computing device (e.g. the first computing device 1) is transitioned into a secure operation mode. Transitioning a first computing device into a secure operation mode may be performed responsive to the receipt of a command, e.g. a migration command, by the first computing device. Transitioning a first computing device into a secure operation mode may be effected in any of the manners described above in relation to the operation of the first computing device 1.

Blocks 702 and 703 correspond to blocks 401 and 402, respectively, of FIG. 4, and may be performed in the same manner. Blocks 702 and 703 are performed whilst the first computing device is in the secure operation mode.

In block 701, a second computing device (e.g. the second computing device 2) is transitioned into a secure operation mode. Transitioning a second computing device into a secure operation mode may be performed responsive to the receipt of a command, e.g. a migration command, by the second computing device. Transitioning a second computing device into a secure operation mode may be effected in any of the manners described above in relation to the operation of the second computing device 2.

Blocks 705, 706 and 707 correspond to blocks 403, 404 and 405, respectively, of FIG. 4, and may be performed in the same manner. Blocks 705, 706 and 707 are performed whilst the second computing device is in the secure operation mode.

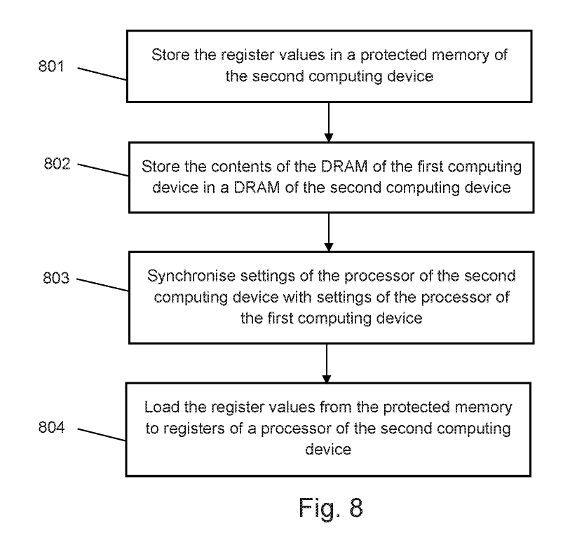

In some examples, the register values of the processor of a first (source) computing device may not fully capture the internal state of the processor of the first computing device. Therefore, some examples of a method for migrating a live operating system from a first (source) computing device to a second (target) computing device comprise synchronising settings of the processor of the second computing device with settings of the processor of the first computing device. One such example is illustrated by FIG. 8.

FIG. 8 is a flowchart of an example method for execution by an example second (target) computing device. Blocks 801, 802 and 804 correspond to blocks 403, 404 and 405, respectively, of FIG. 4, and may be performed in the same manner. In block 803, settings of the processor of the second computing device are synchronised with settings of the processor of the first computing device. Block 803 may be performed before block 804. Synchronising settings of the processor of the first computing device with settings of the processor of the second computing device may comprise the secure code component of the second computing device reconfiguring a memory management unit (MMU) of the second computing device.

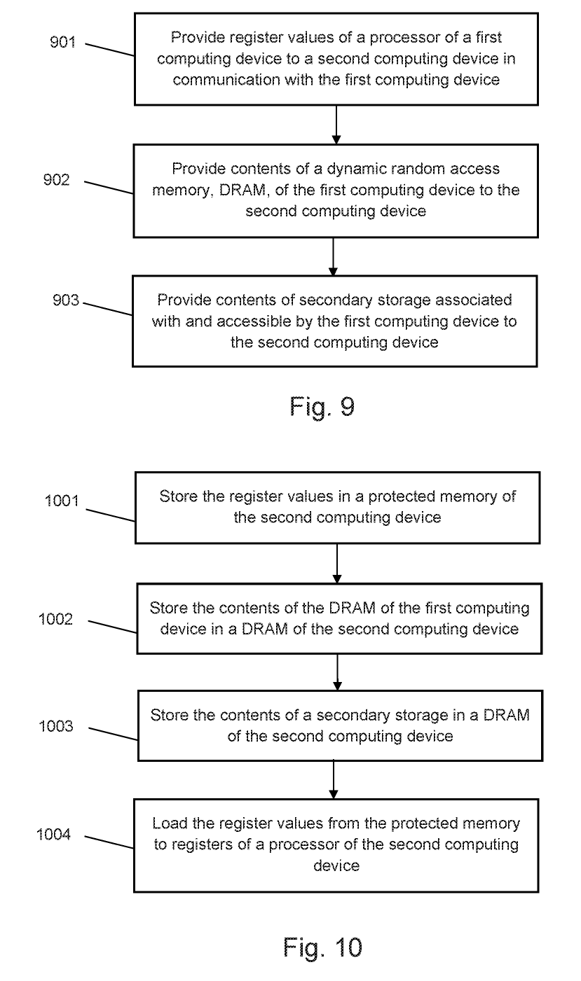

In some examples a secondary storage is associated with and accessible by a source computing device. In such examples, data contained in the secondary storage is made available to a target computing device during a migration process. One such example is illustrated by FIG. 9.

FIG. 9 is a flowchart of an example method for execution by an example first (source) computing device (e.g. the first computing device 1) and an example second (target) computing device (e.g. the second computing device 2). Blocks 901 and 902 correspond to blocks 401 and 402 of FIG. 4, and may be performed in the same manner. In block 903, contents of a secondary storage (e.g. the secondary storage 30) associated with and accessible by the first computing device are provided to the second computing device. The secondary storage may have any of the features described above in relation to the operation of the secondary storage 30. Providing the contents of the secondary storage may be effected in any of the manners described above in relation to the operation of the first computing device 1.

In some examples the second computing device may not be coupled to the secondary storage, and/or may not be able to access the secondary storage. In such examples the first computing device may provide the contents of the secondary storage to the second computing device directly, e.g. by sending the contents via a network. In some such examples the second computing device may store the contents of the secondary storage in a memory (e.g. the DRAM 22, or a non-volatile memory connected to the second computing device) of or accessible by the second computing device. One such example is illustrated by FIG. 10.

FIG. 10 is a flowchart of an example method for execution by an example second (target) computing device (e.g. the second computing device 2). Blocks 1001, 1002 and 1004 correspond to blocks 403, 404 and 405 of FIG. 4, and may be performed in the same manner. In block 1003, contents of a secondary storage (e.g. the secondary storage 30) associated with and accessible by the first computing device, which have been made available to the second computing device, are stored (e.g. by the second computing device 2) in a DRAM (e.g. the DRAM 22) of the second computing device. Storing the contents of the secondary storage may be effected in any of the manners described above in relation to the operation of the second computing device 2.

In some examples (not illustrated) a second computing device is selected to be a target computing device which receives an operating system from a first, source computing device during a migration process, based on whether properties of the second computing device meet certain predefined criteria. The properties of the second computing device may comprise any of the properties described above in relation to the operation of the second computing device 2. The predefined criteria may have any of the features described above in relation to the operation of the second computing device 2. In such examples the method of FIG. 4 may be performed in dependence on the second computing device 2 meeting the predefined criteria. In some examples the method of FIG. 4 may comprise an optional block, to be performed before block 401, of selecting a second computing device. Selecting a second computing device may comprise identifying a computing device which is coupled to the first computing device 1 and which has properties meeting the predefined criteria. Selecting a second computing device may comprise determining whether a computing device coupled to the first computing device 1 has properties which meet the predefined criteria. Selecting a second computing device may comprise coupling a computing device which has properties which meet the predefined criteria to the first computing device 1.

Examples in the present disclosure can be provided as methods, systems or machine readable instructions. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules or engines of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

We claim:

1. A method for migrating a live operating system from a first computing device to a second computing device, the method comprising:
(a) providing register values of a processor of a first computing device to a second computing device which is in communication with the first computing device;
(b) providing contents of a dynamic random access memory, DRAM, of the first computing device to the second computing device;
(c) storing the register values in a protected memory of the second computing device, wherein the protected memory is separate from a memory used by the second computing device during normal operation of the second computing device;
(d) storing the contents of the DRAM of the first computing device in a DRAM of the second computing device; and
(e) loading the register values from the protected memory to registers of a processor of the second computing device.

2. A method in accordance with the method of claim 1, wherein (a) and (b) are performed by a secure code component comprised in the first computing device and (c), (d) and (e) are performed by a secure code component comprised in the second computing device.

3. A method in accordance with the method of claim 2, wherein the secure code component comprised in the first computing device and/or the secure code component comprised in the second computing device comprises one of: a piece of trusted code, trusted firmware, a trusted execution environment, TEE.

4. A method in accordance with the method of claim 1, further comprising:
receiving, by the first computing device, a migration command, wherein (a) and (b) are performed responsive to the first computing device receiving a migration command; and
receiving, by the second computing device, a migration command, wherein (c) and (d) are performed responsive to the second computing device receiving a migration command.

5. A method in accordance with the method of claim 1, wherein normal operation of the first computing device is suspended during the performing of (a) and (b) and normal operation of the second computing device is suspended during the performing of d and (e).

6. A method in accordance with the method of claim 1, further comprising transitioning the first computing device to a secure operation mode and performing (a) and (b) whilst in the secure operation mode, and transitioning the second computing device to a secure operation mode and performing (c), (d) and (e) whilst in the secure operation mode.

7. A method in accordance with the method of claim 1, further comprising, before the performing of (e), synchronising settings of the processor of the second computing device with settings of the processor of the first computing device.

8. A method in accordance with the method of claim 1, wherein (e) is performed automatically, responsive to the completion of the performance of (c) and (d).

9. A method in accordance with the method of claim 1, wherein:
performing (a) comprises storing register values of the processor of the first computing device in a secure shared memory accessible by the first computing device and the second computing device, and retrieving the stored register values of the processor of the first computing device from the secure shared memory; and
performing (b) comprises storing contents of the DRAM of the first computing device a secure shared memory accessible by the first computing device and the second computing device, and retrieving contents of the DRAM of the first computing device from the secure shared memory.

10. A method in accordance with the method of claim 1, wherein:
performing (a) comprises sending the register values of the processor of the first computing device to the second computing device over a network; and
performing (b) comprises sending the contents of the DRAM of the first computing device to the second computing device over a network.

11. A method in accordance with the method of claim 1, wherein performing (b) comprises providing regions of the address space of the DRAM which contain data and not providing regions of the address space of the DRAM which do not contain data.

12. A method in accordance with the method of claim 1, further comprising providing the contents of a secondary storage associated with and accessible by the first computing device to the second computing device.

13. A method in accordance with the method of claim 12, wherein the secondary storage is encrypted and is also accessible by the second computing device, and wherein providing the contents of the secondary storage to the second computing device comprises providing an encryption key for the secondary storage to the second computing device, to enable the second computing device to decrypt the secondary storage.

14. A source computing device, comprising:
a dynamic random access memory, DRAM, for storing data;
a processor; and
a secure code component to be executed in response to a migration command received by the source computing device;
wherein the secure code component comprises instructions which, when executed, cause the processor to:
make available, to a target computing device, register values of the processor; and
make available, to the target computing device, data stored in the DRAM.

15. A target computing device, comprising:
a dynamic random access memory, DRAM, for storing data;
a processor;
a protected memory which is separate from a memory used by the target computing device during normal operation of the target computing device; and
a secure code component to be executed in response to a migration command received by the target computing device;
wherein the secure code component comprises instructions which, when executed, cause the processor to:
receive register values of a processor of a source computing device;
store the received register values in the protected memory;
receive data stored in the DRAM of a source computing device;
store the received data in a DRAM of the target computing device; and
load the register values from the protected memory to registers of the processor.
